(19) United States
(12) Patent Application Publication
(10) Pub. No.: US 2005/0286435 A1
(43) Pub. Date: Dec. 29, 2005

(54) Remote management system

(76) Inventors: Yukio Ogawa, Tokyo (JP); Tomoichi Ebata, Sagamihara (JP); Eiji Ohira, Hamura (JP)

Correspondence Address: MCDERMOTT WILL & EMERY LLP, 600 13th Street, N.W., Washington, DC, 20005-3096, US

(21) Appl. No.: 10/963,760

(22) Filed: Oct. 14, 2004

(30) Foreign Application Priority Data
Jun. 28, 2004 (JP) 2004-189105

(51) Int. Cl. H04L 12/26; H04J 3/12

(52) U.S. Cl. 370/252; 709/223

(57) ABSTRACT

A remote management system includes a managed device and a management device connected via a network, where events occurring in the managed device are managed via an event system scheme which can be adapted to a number of managed devices. A management module in the managed device detects an event occurring in the managed device and locates one or more enquiry destinations corresponding to the event, in an event enquiry destination table. An enquiry destination is assigned in cases where one or more enquiry destinations corresponding to the event identifier have not been defined in the event enquiry destination table. The management module makes an enquiry by sending an identifier for the event to the management device. Enquiries are made simultaneously or consecutively to the one or more enquiry destinations.

### INCORPORATED BY REFERENCE

This application claims priority based on a Japanese patent application, No. 2004-189105 filed on Jun. 28, 2004, the entire contents of which are incorporated herein by reference.

### BACKGROUND OF THE INVENTION

The present invention relates to technology for monitoring devices, gathering information, analyzing information, and presenting information, from a remote point, via a network, such as the Internet, or the like.

In an environment where a device under management (hereinafter, called a “managed device”), and a device performing management (hereinafter, called a “management device”) are connected via a network, such as the Internet, when the management device implements a countermeasure from a remote point in response to an event, such as a fault, or the like, that has occurred in the managed device, then a procedure is used whereby the managed device sends an event report to the management device, whereupon the management device gathers information by making an enquiry to the managed device, and provides event countermeasure information.

In the aforementioned procedure, in order to communicate with the managed device, the management device must identify the address of the managed device. Furthermore, if a firewall is provided on the managed device side, then the management device must change the settings in order to pass through the firewall.

On the other hand, the remote management system described in the Japanese Laid Open Patent Publication No. 2004-510231, for example, seeks to achieve a method for providing information from a management device to a managed device, via a network such as the Internet, without changing the firewall settings on the managed device side, even if the address of the managed device is not known.

More specifically, a management module provided in the managed device reports identification information which allows the aforementioned managed device to be distinguished from other similar managed devices, such as the device type, name, manufacturer, model, serial number, UUID (Universally Unique IDentifier), or the like, to the management device, in a data format such as XML (Extensible Markup Language), or the like, by using a communications protocol consisting of a request and response pairs, such as HTTP (HyperText Transfer Protocol), or the like. In the management device receiving this report, specific information is located in this identification information and sent to the management module, in a response to the report.

Furthermore, in the communications protocol described in Don Box, and 7 others, “Simple Object Access Protocol (SOAP) 1.1”, 8 May 2000, World Wide Web Consortium, <URL: http://www.w3.org/TR/2000/NOTE-SOAP-20000508/>.”, a setup is specified for performing data access between a management device and a managed device via the Internet, without changing the firewall settings.

More specifically, the managed device transmits a message in XML format to the management device, using HTTP, or the like, as the lower layer protocol, accesses the data in the management device and gathers information obtained on the basis of this data.

### SUMMARY OF THE INVENTION

In a conventional remote management system, in order to distinguish the aforementioned managed device from other similar managed devices, the management device receives identification information, such as the device type, name, manufacturer, model, serial number, UUID, or the like, and it locates specific information for that managed device by using the identification information as a key. Therefore, each time a managed device is added, it is necessary to add settings in the aforementioned management device, such as specific information relating to the managed device, and the workload required is proportional to the number of managed devices.

Moreover, since a conventional management device does not have a system for providing information in a interactive manner via an operator, it may be difficult to provide a response in cases where the management device has received a report from a managed device in relation to an unexpected situation that has arisen in the managed device.

The present invention provides a scalable remote management system which does not require changing of firewall settings on the managed device side, or identification of managed device addresses, and which, furthermore, does not require addition of settings to the management device when a managed device is added.

Furthermore, it provides a remote management system wherein information can be provided in an interactive fashion, via an operator, if the management device receives a report from a managed device.

More specifically, one aspect of the present invention is a remote management system comprising a managed device and a management device connected via a network, events occurring in the managed device being managed by means of an event scheme which can be adapted to a plurality of managed devices.

The managed device includes a management module, and the management module includes: means for detecting an event occurring in the managed device; means for locating one or more enquiry destinations corresponding to the event, in an event enquiry destination table; means for assigning an enquiry destination in cases where one or more enquiry destinations corresponding to the event identifier have not been defined in the event enquiry destination table; means for making an enquiry by sending an identifier for the event to the management device; and means for making enquiries simultaneously or consecutively to the one or more enquiry destinations.

The management device includes: means for receiving an enquiry from the management module; means for accepting the event; means for managing the processing status of the event by using an event status management table; means for locating countermeasure information corresponding to the event identifier in an event countermeasure information table; means for locating countermeasure information corresponding to an enquiry condition of the management module, in the event countermeasure information table; means for assigning countermeasure information for cases where no countermeasure information corresponding to the event identifier is registered in the event countermeasure information table; means for assigning countermeasure information indicating an operator call-up in cases where no countermeasure information corresponding to the event identifier is registered in the event countermeasure information table; and means for sending an event acceptance number and the countermeasure information, to the management module.

Furthermore, the management module includes means for repeatedly sending an enquiry to the management device, until the countermeasure information has been provided; means for providing additional information to the management device when repeating an enquiry; means for implementing the countermeasure information received from the management device; and means for reporting that a countermeasure for the event has been completed, to the management device.

Moreover, the management module includes means for accepting an event countermeasure completion report from the management module.

Furthermore, the management module includes: means for providing a report to the administrator of the managed device, if no response to the enquiry has been obtained from the management device, or if no countermeasure information has been provided by the management device, or if no response to the event countermeasure completion report has been obtained from the management device; and means for reporting countermeasure information received from the management device, to the administrator of the managed device; and therefore a management is achieved whereby the hardware and software of the managed device is managed by the management device.

According to the remote management system of the embodiment of the invention described above, it is possible to achieve simple and scalable remote management, without needing to change firewall settings on the managed device side or to identify the addresses of managed devices, and furthermore, without needing to add settings in the management device if the number of managed devices is increased.

Moreover, managed devices can acquire event countermeasure information from one or more than one management device, and management of the managed devices can be implemented in a shared or co-operative fashion, by one or more management devices.

Furthermore, the management device can change the countermeasure information provided in accordance with enquiry conditions from the managed device, and hence countermeasures corresponding to the actual situation in the managed device can be provided.

Furthermore, since the management device can exchange information with the managed device in an interactive manner, via an operator, it is possible to implement countermeasures for an event reliably, even if an unexpected event has occurred in the managed device.

According to the present invention, it is possible to achieve a remote management system capable of providing simple and scalable remote management.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 shows the composition of a system in the embodiment.

FIG. 2 shows a processing flow in a management module according to the embodiment.

FIG. 3 shows a processing flow in a management device upon receiving an enquiry in the embodiment.

FIG. 4 shows the processing flow in a management device upon receiving a countermeasure completion report in the embodiment.

FIG. 5 shows an event enquiry destination table according to the embodiment.

FIG. 6 shows an event countermeasure information table according to the embodiment.

FIG. 7 shows an event status management table according to the embodiment.

FIG. 8 shows a basic message sequence according to the embodiment.

FIG. 9 shows a message sequence when working via an operator according to the embodiment.

FIG. 10 shows a message sequence when presenting additional information to an operator according to the embodiment.

FIG. 11 shows a message sequence in the case of a plurality of simultaneous enquiries according to the embodiment.

FIG. 12 shows a message sequence in the case of a plurality of consecutive enquiries according to the embodiment.

FIG. 13 shows a message sequence in the case of hierarchical enquiries according to the embodiment.

### DETAILED DESCRIPTION OF THE EMBODIMENTS

Hereinafter, an embodiment of the present invention is described in detail with reference to the drawings. The following description does not limit the technical scope of the present invention. In the following description, constituent elements having the same functions are labeled with the same reference numerals. Furthermore, if constituent elements having the same functions are implemented repeatedly in the same device, or are implemented in different devices, and the distinction therebetween is not clear, then identification numbers are added in parenthesis after the reference numeral.

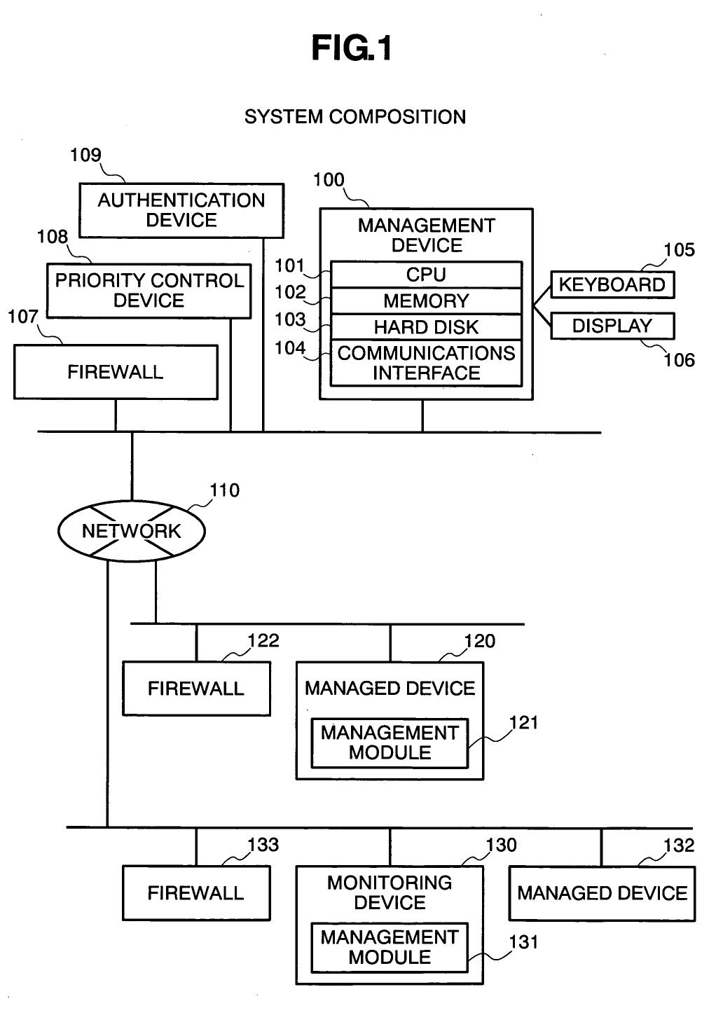

FIG. 1 is a diagram showing the general composition of an remote management system relating to an embodiment of the present invention. A management device 100, a managed device 120 and a similar managed device 132 are connected via a network 110.

The network 110 is the Internet or an Intranet. If the network 110 is the Internet, for example, then a firewall 122 may be provided at the boundary between the managed device 120 and the network 110, a firewall 133 may be provided at the boundary between the managed device 132 and the network 110, and a firewall 107 may be provided at the boundary between the management device 100 and the network 110.

In the management device 100, if the priority of communications from the managed device 120 and the managed device 132 is to be controlled, then a priority control device 108 is provided at the boundary with the network 110. Furthermore, in the management device 100, if the communications from the managed device 120 and the managed device 132 are to be authenticated, then an authentication device 109 is provided at the boundary with the network 110.

The management device 100 is a general information processing device, such as a personal computer, server device, or the like, which is constituted by a CPU (Central Processing Unit) 101, a memory 102, a hard disk 103, a communications interface 104, a keyboard 105, a display 106, and the like. In the management device 100, the various functions described below are realized by means of the CPU 101 calling up programs from the hard disk 103 to the memory 102, and executing these programs, under the control of the operating system.

The managed device 120, the managed device 132, and a monitoring device 130 for monitoring the managed device 132, disposed in the same location as the managed device 132, are all information processing devices similar to the management device 100.

The managed devices 120 and 132 are now described in further detail. In the present embodiment, when the managed devices 120 and 132 send messages to the management device 100, they also exchange messages between each other.

Therefore, in the present embodiment, it is also possible to respond to cases where the management device 100 cannot access the managed devices 120 and 132 directly, due to the firewalls 122, 133, or the like, provided at the managed devices 120 and 132, or cases where the management device 100 cannot access the managed devices 120 and 132, due to the address of the managed device 120 or 132 being unknown or changing on a continuous basis.

Examples of managed devices 120 and 132 in the former case include, in addition to standard personal computers or servers as described above, devices such as printers, copying machines, information appliances, and the like. Examples of managed devices 120 and 132 in the latter case include mobile devices, such as car telephones, portable telephones, or the like, which can be connected to a network.

A management module 121 implemented in the managed device 120 manages the managed device 120 by communicating with the management device 100. The management module 121 may be stored on a hard disk as a standard program, and executed by the CPU 101 on the memory. Alternatively, it may also be stored in a built-in device.

The management module 131 provided in the monitoring device 130 has the function of managing the managed device 132 via the network, by communicating with the management device 100. The management module 121 and the management module 131 are disposed in different positions, but they have equivalent functions. In the following description, the processing implemented by the management module 121 is described as an example, but the processing implemented by the management module 131 is similar to this processing.

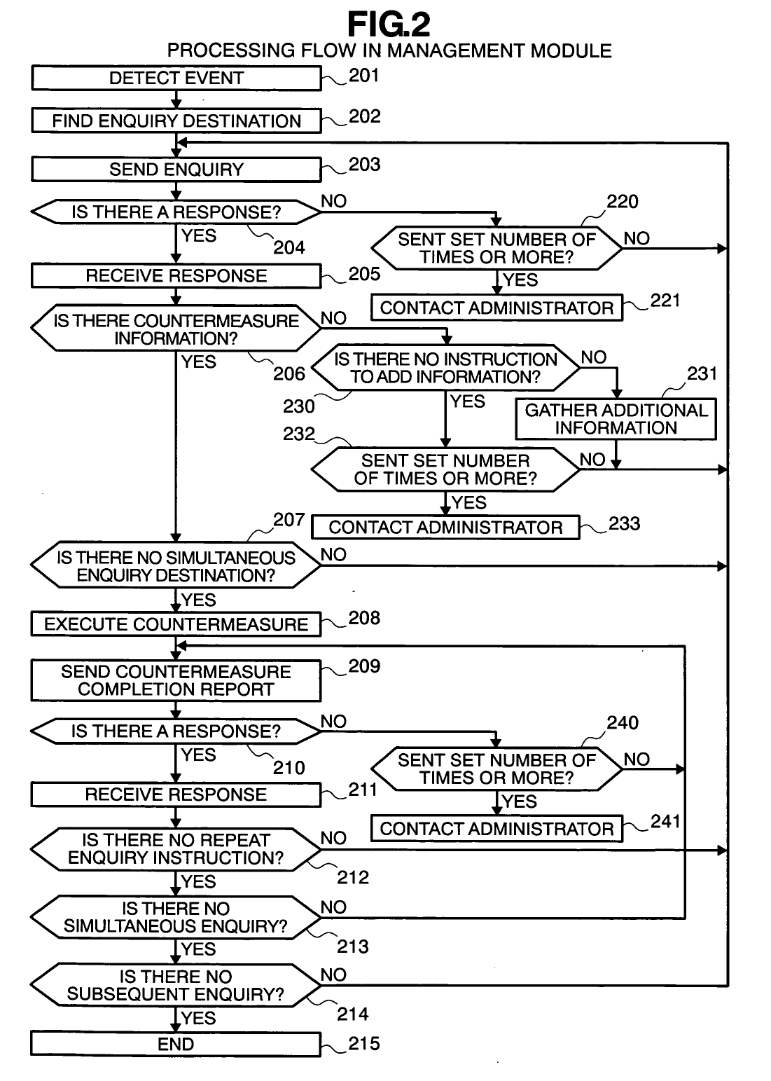

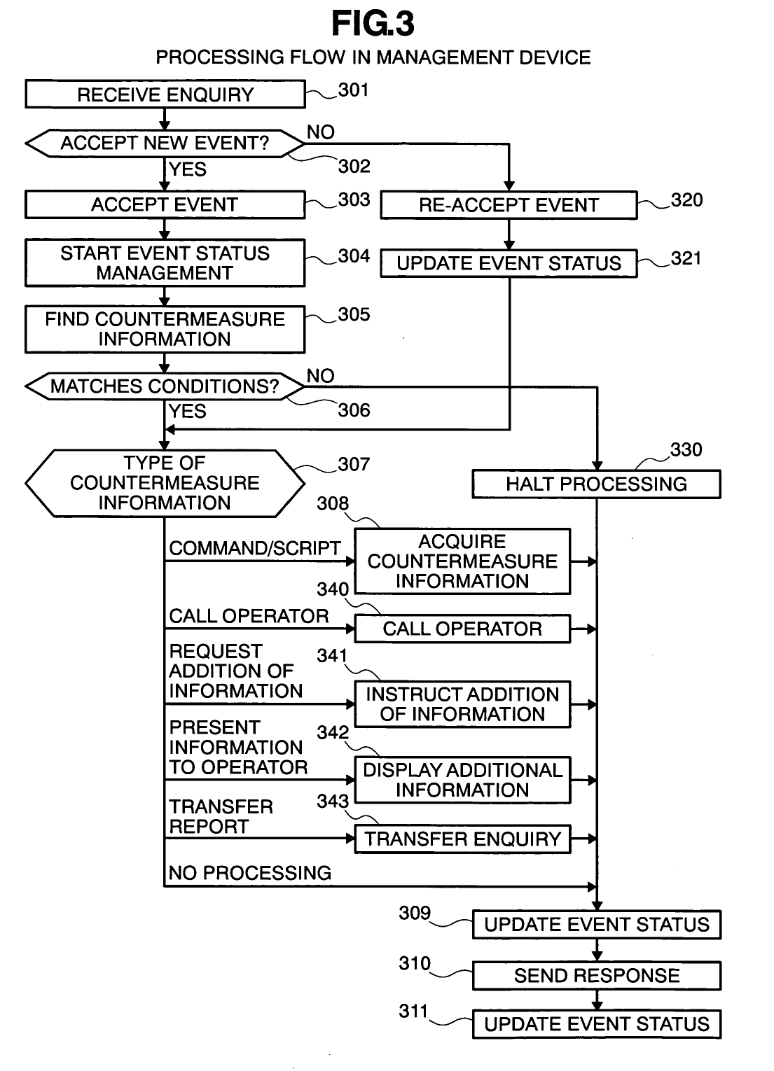

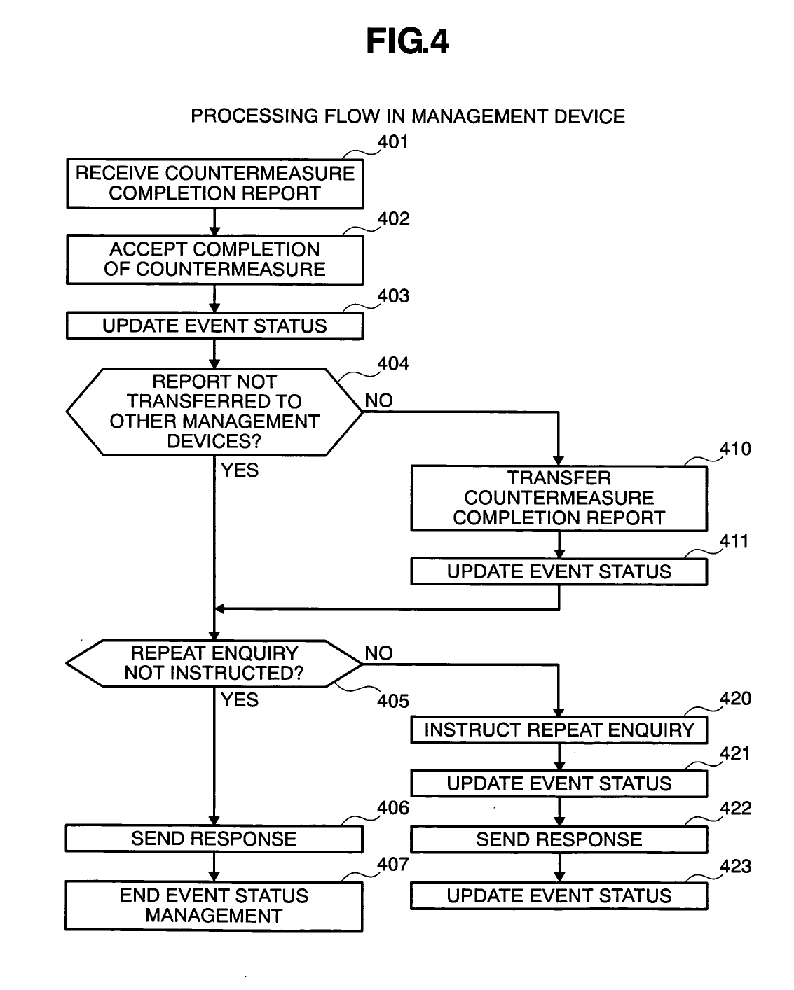

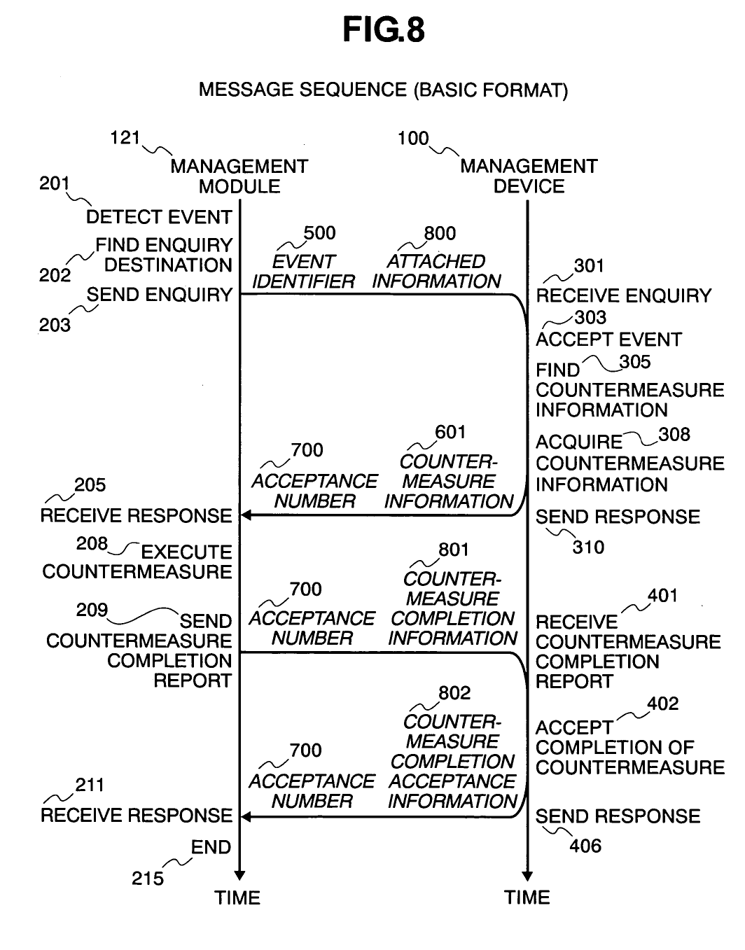

Below, the processing of the events occurring in the managed device 120 is described with reference to the processing flow of the management module 121 shown in FIG. 2, the processing flow of the management device 100 shown in FIG. 3 and FIG. 4, and the sequence of messages exchanged between the management module 121 and the management device 100 illustrated in FIG. 8 to FIG. 13.

Firstly, a case where the management module 121 implements event countermeasures by exchanging basic messages with the management device 100 is described with respect to FIG. 8, following a time sequence.

In (“Detect event” 201), the management module 121 detects that an event has occurred in the managed device 120.

An “event” is an error, alarm, or the like, indicating that the numerical figures relating to the composition or function of the hardware or software of the managed device 120, such as the CPU, memory, hard disk or application of same, has exceeded a certain set value, or that a specific operation has been performed. An event may also be generated in relation to the composition or functions of the hardware or software of the management module 121 itself, in addition to the managed device 120. Furthermore, an event may be generated at periodic intervals, such as a regular report, rather than at indefinite intervals.

An event is managed by means of an event identifier, such as a number, which allows that event to be identified universally. The event identifier is determined for each event occurring in the managed device 120, and it is determined on the basis of a standard information management scheme, such as MIB (Management Information Base), CIM (Common Information Model), or the like, or a hardware or software information management scheme that is common to a plurality of managed devices. Thereby, the same identifier can be assigned to the same event, even if it occurs in different managed devices, and hence event countermeasures can be standardized.

Furthermore, respectively unique event identifiers may be assigned to events which do not coincide with the standard information management scheme or the common information management scheme, or events which are unique to one managed device 120 only. However, below, a method is described wherein the events are managed universally using the event identifier “Other (default)”.

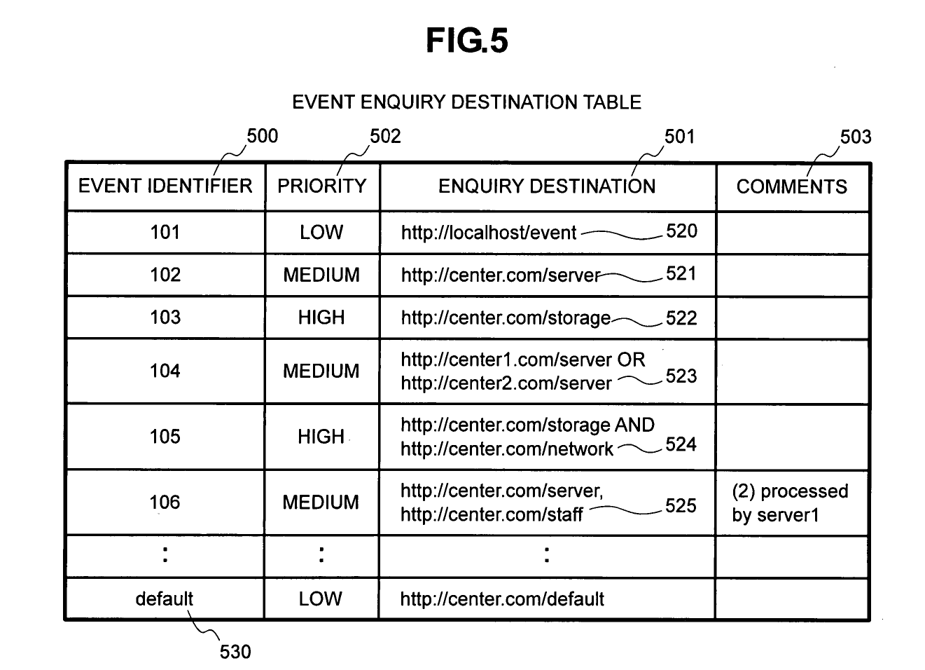

In (“Find enquiry destination” 202), the management module 121 searches the event enquiry table shown in FIG. 5 to find the enquiry destination 501 corresponding to the event identifier 500. Generally, the enquiry destination 501 is an external management device 100 indicated by an address, such as “http://center.com/server” 521 or “http://center.com/storage” 522, but it may also be the managed device 120 or the management module 121 itself, as in “http://localhost/event” 520. In this case, event countermeasure information similar that that in the management device 100 described hereinafter is stored in the managed device 120 or the management module 121.

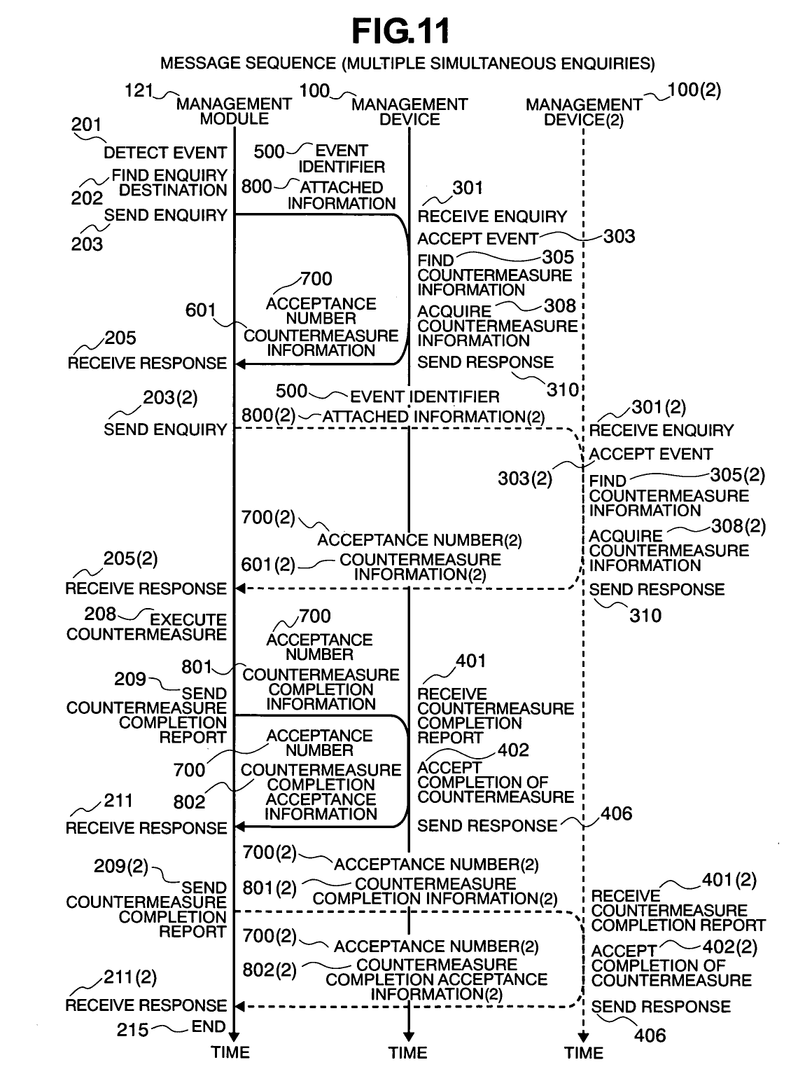

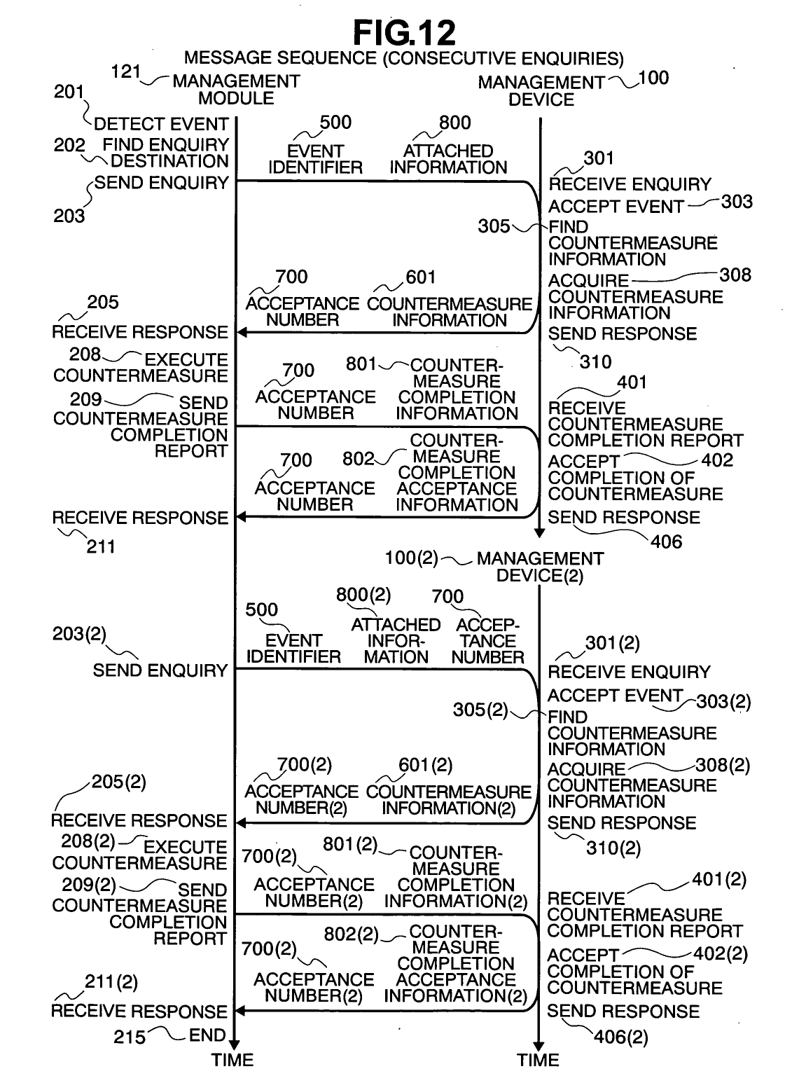

A plurality of destinations may also be registered for the enquiry destination 501. The actual plurality of destinations are generally in different management devices 100, but they may also be in the same management device 100. The entry “http://center1.com/server OR http://center2.com/server” 523 is an example indicating a reserve destination, the details of which will be described when describing (“Receive response” 205). The entry “http://center.com/storage AND http://center.com/network” 524 is an example indicating a plurality of simultaneous destinations, the details of which will be described with reference to FIG. 11. The entry “http://center.com/server, http://center.com/staff” 525 is an example indicating a plurality of consecutive destinations, the details of which will be described with reference to FIG. 12.

If no event identifier 500 is found corresponding to an event that has occurred, then the identifier “default” 530 is used to indicate an event in the category “Other”. The enquiry destination in cases where no event identifier is defined for the detected event is determined by “default” 530 in the event identifier 500. By this means, an enquiry destination 501 is determined for an event which does not coincide with a standard information management scheme or a common information management scheme, thereby making it possible to handle events of this kind also.

Moreover, a processing priority 502 may be determined for the respective event identifiers 500, thereby defining the priority of processing in cases where a plurality of events occurs simultaneously.

FIG. 5 relates to an example where HTTP is used as the communications protocol, and therefore “http://” is stated as the enquiry destination 501, but if HTTPS is used, then the enquiry destination should be registered in a format matching the communications protocol used, namely, “https://”.

In (“Send enquiry” 203), the management module 121 makes an enquiry regarding an event, to the management device 100 which is the located enquiry destination 501.

The communications protocol between the management module 121 and the management device 100 may be any type of protocol, provided that it uses paired transmission and reception operations. Even if a firewall 122 is situated on the management module 121 side, it is not necessary to make special settings in the firewall 122, provided that HTTP, SOAP, or the like, which permits transmission to external devices, is used as the communications protocol.

The transmission contains the identifier 500 of the event that has occurred in the managed device 120, and attached information 800 which is appended to this identifier. The transmission contents may be written in any format which can be interpreted by both the management module 121 and the management device 100, such as XML, or the like. Below, it is assumed that the messages sent and received between the management module 121 and the management device 100 are written in this format.

The attached information 800 is any information required for processing the event, such as the event priority 502, the event occurrence time, the name, model or serial number of the hardware or software relating to the event, an event log, the location of the managed device 120, the administrator, or the like.

In (“Receive enquiry” 301), the management device 100 receives an enquiry relating to the event occurring in the managed device 120, from the management module 121.

Before the management device 100 receives the enquiry, the priority control device 108 may identify information, such as the destination address or the sender address of the enquiry message, or the enquiry destination 501, the priority 502 of the event contained in the attached information 800, or the like, and it may carry out priority control processing. More specifically, if the priority control device 108 has received a plurality of enquiry messages simultaneously, then it forwards these to the management device 100 in order, starting with the message having the highest priority.

Furthermore, the authentication device 109 may carry out authentication of the event messages, by using authentication information, such as a user name, password, or certificate appended to the enquiry message, or authentication information such as a user name, password, or certificate contained in the attached information 800.

In (“Accept event” 303), the management device 100 accepts the event, analyzes the enquiry message, and investigates whether or not it has an acceptance number. If it has an acceptance number, then it is determined that the event has already been accepted previously.

If there is no acceptance number, then it is judged that the event is a newly accepted event, and a new acceptance number is assigned to the number or identifier which uniquely identifies the event for which the enquiry has been received.

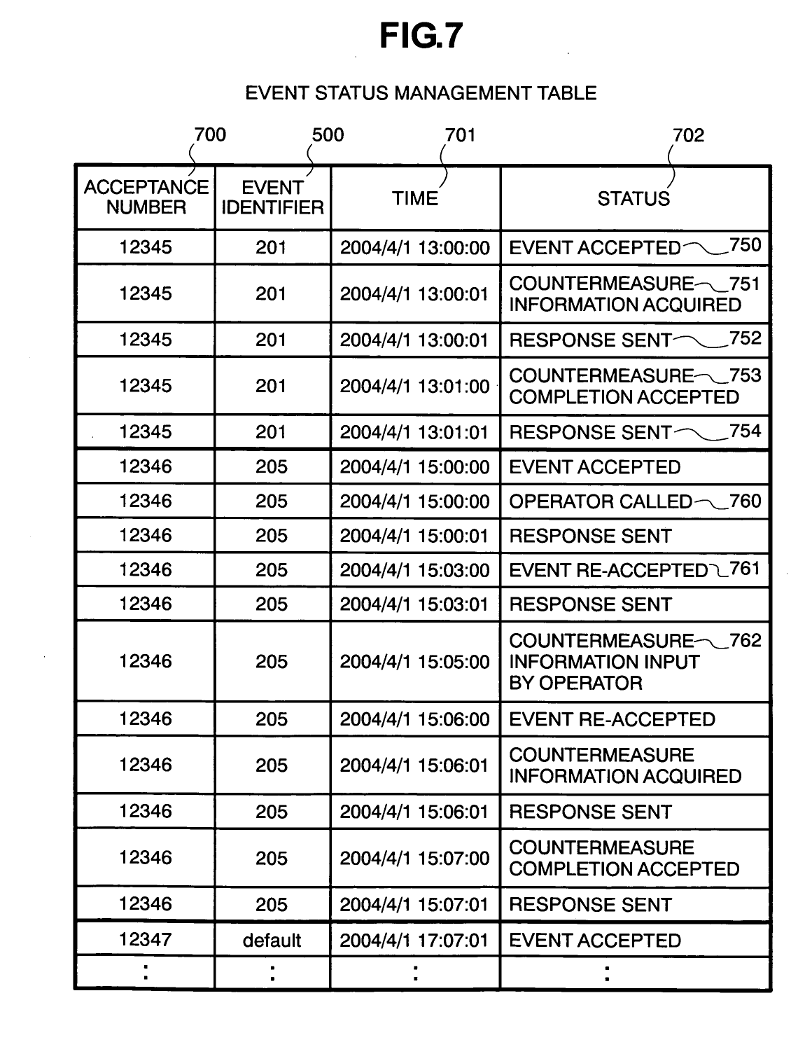

In (“Start event status management” 304) in FIG. 3, the management device 100 starts management of the event status, by respectively registering the assigned acceptance number as the acceptance number 700 in the event status management table shown in FIG. 7, the identifier of the event for which an enquiry has been received, as the event identifier 500, the timing at which the enquiry was received, as the timing 701, and the processing status, such as “Event accepted” 750, as the status 702.

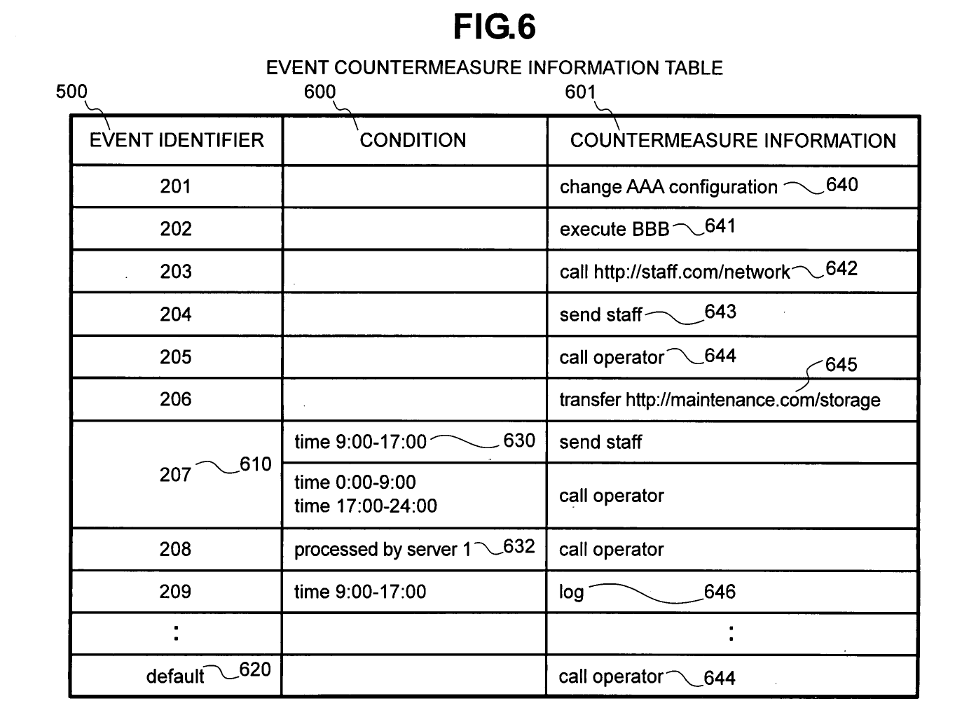

In (“Find countermeasure information” 305), the management device 100 finds countermeasure information for the event, using the event identifier 500 as a key. The management device 100 analyzes the enquiry message in order to investigate whether or not it contains an event identifier 500. If it contains an event identifier 500, then the countermeasure information 601 corresponding to this event identifier 500 is located by searching an event countermeasure information table, such as that shown in FIG. 6.

A condition 600 may be stated in relation to the countermeasure information 601. As shown by the case (610) where the event identifier 500 is “207”, a plurality of conditions 600 may be stated for any one event identifier 500, different countermeasure information 601 being established for each condition 600. The condition 600 is, for example, a time period setting, such as “time 9:00-17:00” (630), or a condition indicating previous processing by another management device, such as “processed by server 1” (632).

In (“Halt processing” 330) in FIG. 3, it is also possible to set conditions 600 on the basis of the attached information 800 contained in the enquiry message, such as the event priority 503, the event occurrence time, the name or model of the hardware or software relating to the event, or the location of the managed device 120, the administrator, or the like. If a condition 600 is set, then the management device 100 obtains the countermeasure information 601 matching the condition 600, from the countermeasure information 601 corresponding to the event identifier 500. If there is no matching countermeasure information 601, then event processing is halted.

If an event identifier 500 corresponding to the received event identifier 500 is not found in the event countermeasure table shown in FIG. 6, then the countermeasure information 601 registered for “default” (620) in the table is located. The “default” event identifier 500 (620) states the countermeasure information 601 for cases where the value of the received event identifier 500 is “default”, or cases where the received event identifier 500 is not registered in the event countermeasure information table. By this means, the countermeasure information 601 is determined for an event which does not coincide with a standard information management scheme or a common information management scheme, and hence such events can also be handled.

In (“Acquire countermeasure information” 308), the management device 100 acquires the countermeasure information 601 on the basis of the search results. The countermeasure information 601 is a configuration file change command for the managed device 120 or management module 121, such as “change AAA configuration” (640), a command execution instruction for the managed device 120 or management module 121, such as “execute BBB” (641), a command to report to another device, such as “call http://staff.com/network” (642), or a command indicating an executive instruction for a patch file or module attached to the countermeasure information 601, or the like, or a script defining the execution of that command, or the like.

A script may be created dynamically, by writing a template in advance, and then inserting the attached information 800 contained in the enquiry message, such as the name, model, serial number, or the like, of the hardware or software relating to the event, into this template. The countermeasure information 601 for an event is determined in association with the event identifier 500, and the attached information 800 provides supplementary information to the event countermeasure information 601.

The countermeasure information 601 has contents such as “send staff” (643), whereby a specialized staff is sent from the management centre where the management device 100 is situated, to the location of the managed device 120, “log” (646), whereby the event enquiry is recorded in a log of the management device 100 or the management module 121, “call operator” (644), whereby an operator is called, or “transfer http://maintenance.com/storage” 645, whereby the enquiry is transferred to another management device, or the like.

In the event countermeasure information table, an operator call, such as “call operator” (644), may be registered as the countermeasure information 601 in a case where the event identifier 500 is “default” (620). Thereby, countermeasures can be implemented for any events which do not coincide with a standard information management scheme or a common information management scheme.

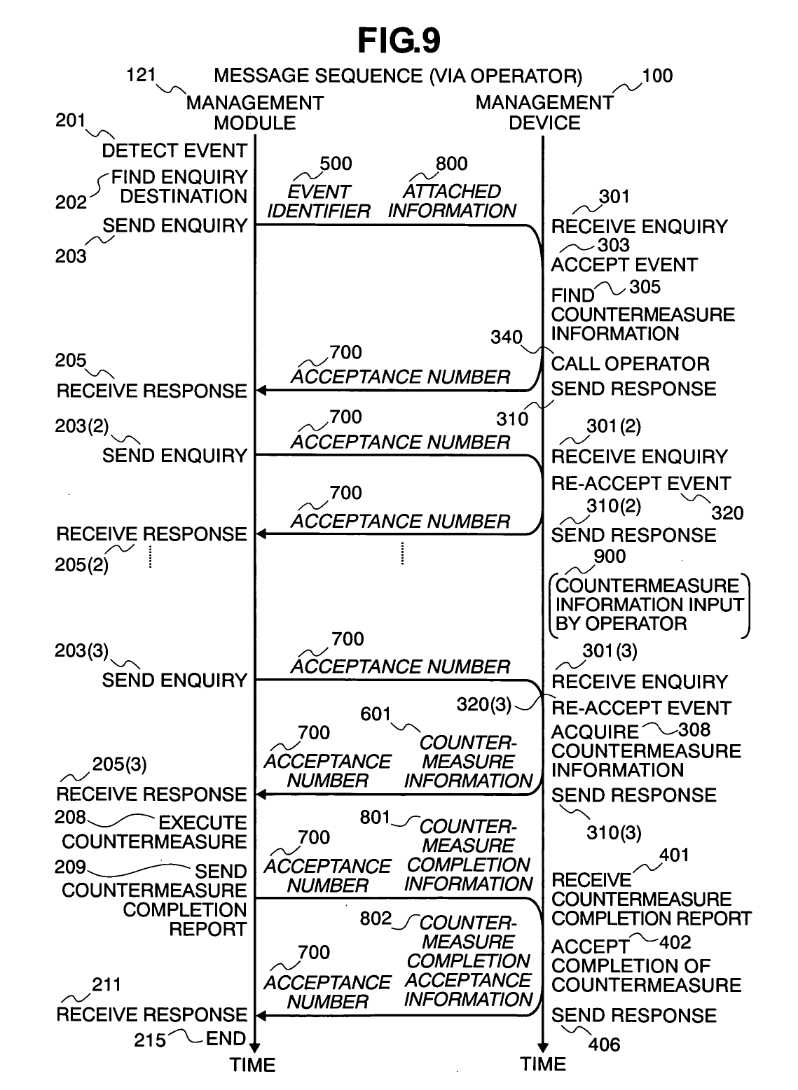

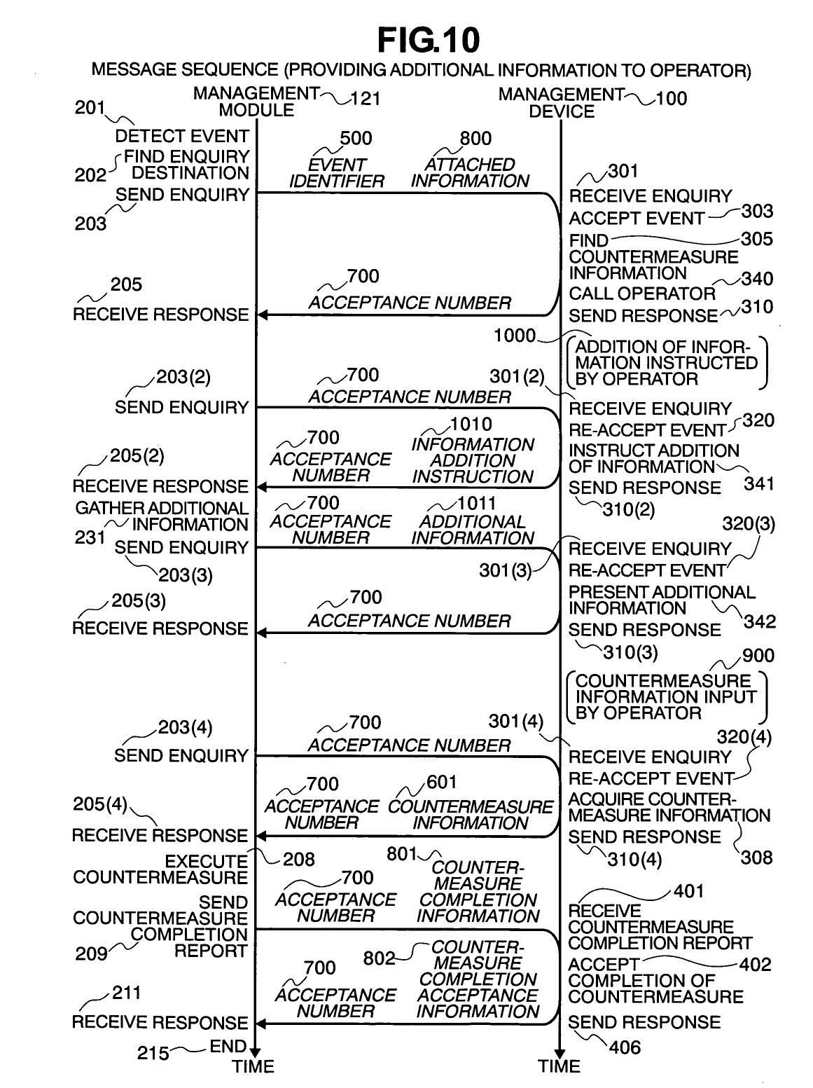

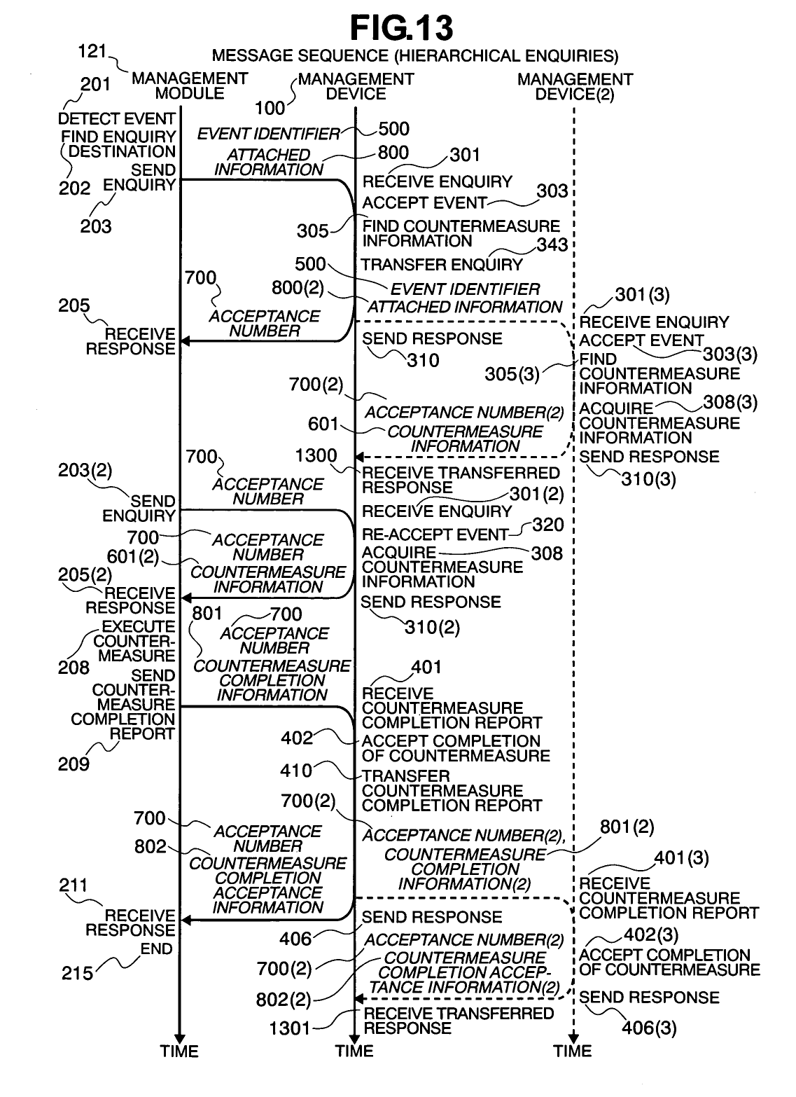

A case where the search result is a call-up, “call operator” (644), is described below when describing FIG. 9 and FIG. 10. A case where the result is “transfer http://maintenance.com/storage” (645) is described below when describing FIG. 13.

In (“Update event status” 309) in FIG. 3, the management device 100 updates the event processing status after acquisition of the countermeasure information 601, by adding an entry in the event status management table such as that shown in FIG. 7 respectively registering the current acceptance number as the acceptance number 700, the current event identifier, as the event identifier 500, the processing time, as the time 701, and the processing status “countermeasure information acquired” (751), as the status 702.

If the event enquiry does not match the condition 600 and the countermeasure information 601 cannot be acquired, then the event processing status is updated by registering a similar entry indicating “countermeasure information could not be acquired” as the status 702, in the event status management table.

In (“Send response2 310), the management device 100 returns a response message corresponding to the message received from the management module 121, containing the acceptance number 700 and the acquired event countermeasure information 601. For example, if an HTTP request is received from the management module 121, then the acceptance number 700 assigned in (“Accept event” 303), and the countermeasure information 601, such as the command or script, acquired in (“Acquire countermeasure information” 308) are included in an HTTP response to this request. The response data is written in any format which can be interpreted by both the management module 121 and the management device 100, such as XML, or the like. If the event enquiry does not match the condition 600 and countermeasure information 601 cannot be acquired, then an identifier indicating a processing halt is included in the countermeasure information 601 that is returned.

In (“Update event status” 311) in FIG. 3, the management device 100 updates the event processing status after transmission of a response, by adding an entry to the event status management table such as that shown in FIG. 7 respectively registering the current acceptance number as the acceptance number 700, the current event identifier, as the event identifier 500, the processing time, as the time 701, and the processing status “Response sent” (752), as the status 702.

In (“Receive response” 205), the management module 121 receives a response message to the enquiry that was sent to the management device 100 in (Send enquiry 203). The management module 121 analyzes the response message, and if it contains an acceptance number 700, then it determines that the event enquiry has been accepted by the management device 100.

If the management module 121 cannot receive a response from the management device 100 within a set time period, then after pausing for a predetermined set time period, it implements (“Send enquiry” 203) again.

In (“Contact administrator2 221) in FIG. 2, if the management module 121 has not received a response from the management device 100 even after repeating the aforementioned retransmission a predetermined number of times, due to a communications fault, or the like, then it records a communications fault, or the like, in the log, reports the details of the situation to the administrator of the managed device 120, either by displaying them on the display monitor of the managed device 120, contacting the administrator by email, or another method.

If a reserve enquiry destination has been specified previously, for example, ““http://center1.com/server OR http://center2.com/server” (523) as in FIG. 5, then in the retransmission of the enquiry, if there is no response from the first enquiry destination, the message is sent to the second enquiry destination. Desirably, the data in the management device 100 forming the first enquiry destination and the data in the other management device 100 forming the second enquiry destination are synchronized.

In (“Execute countermeasure” 208) the management module 121 analyzes the response message, and if it contains a command, script, or the like, in the countermeasure information 601, then it reads in and executes that command, script, or the like. The execution results may be output to a log, or to the display monitor of the management device 120. Furthermore, similar action is taken if the countermeasure information 601 indicates an operator call-up. If the countermeasure information 601 indicates that a specialized staff is to be sent to the location of the managed device 120, then this is reported to the administrator of the managed device 120, either by displaying it on the monitor display of the managed device 120, or by sending an email, or the like.

In (“Send countermeasure completion report” 209), the management module 121 sends the acceptance number 700 of the event and the countermeasure completion information 801 to the management device 100, in order to report the results of executing the countermeasure information 601. The countermeasure completion information 801 is an identifier such as “operation end” which indicates that the countermeasure has been completed. Moreover, the countermeasure completion information 801 may also contain information indicating the results of executing the countermeasure information 601, such as an execution log for the commands or script executed in (“Execute countermeasure” 208), a report log directed to the administrator of the managed device 120, or the like.

Similarly, in (“Execute countermeasure” 208), if there is an error in the execution of the command or script, then an identifier such as “operation error” indicating an error in the countermeasure, or an error log, or the like, is included in the countermeasure completion information 801.

In (“Receive countermeasure completion report” 401), the management device 100 receives the countermeasure completion report sent by the management module 121.

In (“Accept completion of countermeasure” 402), the management device 100 analyzes the countermeasure completion report for the event, and confirms the completion of the countermeasure. The management device 100 analyzes the countermeasure completion report and extracts the acceptance number 700 and the countermeasure completion information 801.

In (“Update event status” 403) in FIG. 4, the management device 100 updates the event processing status, by adding an entry to the event status management table shown in FIG. 7 respectively registering the current acceptance number as the acceptance number 700, the current event identifier, as the event identifier 500, the processing time, as the time 701, and the processing status “Countermeasure completion accepted” (753), as the status 702.

In (“Instruct repeat enquiry” 420), the management device 100 is able to instruct the management module 121 to perform a repeat enquiry for a currently accepted event, in order to gather information about the managed device 120 after a prescribed time period has elapsed, or to provide countermeasure information again to the managed device 120.

In (“Update event status” 421) in FIG. 4, the management device 100 updates the event processing status, by adding an entry to the event status management table shown in FIG. 7 respectively registering the current acceptance number as the acceptance number 700, the current event identifier, as the event identifier 500, the processing time, as the time 701, and the processing status “Repeat enquiry instructed”, as the status 702.

In (“Send response” 406), the management device 100 sends a message to the management module 121 indicating that it has accepted the countermeasure completion report. If countermeasures have been completed, then the management device 100 sends the acceptance number 700 and countermeasure completion acceptance information 802, in a response message to the countermeasure completion report message received from the management module 121. The countermeasure completion acceptance information 802 is an identifier such as “process end”, which indicates termination of the event enquiry process. The countermeasure completion acceptance information 802 may also be blank.

In (“End event status management” 407) in FIG. 4, the management device 100 terminates event status management, by adding an entry to the event status management table shown in FIG. 7 respectively registering the current acceptance number as the acceptance number 700, the current event identifier, as the event identifier 500, the processing time, as the time 701, and the processing status “Response sent” (754), as the status 702.

In (“Send response” 422) in FIG. 4, if a repeat enquiry is instructed, the management device 100 sends the acceptance number 700 and a repeat enquiry instruction in a response message to the message received from the management module 121. A repeat enquiry instruction is an identifier such as “call me again”, and a destination for the repeat enquiry, or the like.

In (“Update event status” 423) in FIG. 4, the management device 100 updates the event status management after sending the response, by adding an entry to the event status management table shown in FIG. 7 respectively registering the current acceptance number as the acceptance number 700, the current event identifier, as the event identifier 500, the processing time, as the time 701, and the processing status “Repeat enquiry instruction sent”, as the status 702.

In (“Receive response” 211), the management module 121 receives a response message to the countermeasure completion report sent to the management device 100 in (“Send countermeasure completion report” 209). The management module 121 analyzes the response message, and if it contains countermeasure completion acceptance information 802, then it determines that the countermeasure completion report has been accepted by the management device 100.

If the response message contains a repeat enquiry instruction, then the sequence returns to (“Send enquiry” 203), and a repeat enquiry relating to the current event is carried out using the acceptance number 700.

In (“Contact administrator” 241) in FIG. 2, if the management module 121 has not been able to receive a response from the management device 100 within a predetermined set time period, then it pauses for a set time period, whereupon it implements the operation (“Send countermeasure completion report” 209) again.

If a response can still not be received from the management device 100, even after performing retransmission a prescribed number of times, due to a communications error, then the contents of this communications error are recorded in a log, and these contents are reported to the administrator of the managed device 120 by displaying them on the display monitor of the managed device 120, contacting the administrator by email, or by some other method.

A communications error may be due to a fault in the firewall 122, the firewall 107, the priority control device 108, the authentication device 109, or the management device 100, a processing capacity overrun due to concentration of the communications data, a fault in the network 110, or a communications bandwidth overrun due to concentration of communications data.

In (“End” 215), if the management module 212 has received the countermeasure completion acceptance information 802 from the management device 100, then it records the contents of this information in a log and terminates the event countermeasure processing.

Next, a case where the management module 121 works with an operator's assistance in exchanging messages with the management device 100 and performing the event countermeasures shown in FIG. 8, will be described in a time sequence with reference to FIG. 9.

In the steps from (“Detect event” 201) to (“Find countermeasure method” 305), the same processing as that in FIG. 8 is implemented.

In (“Call operator” 340), if the search of the event countermeasure information table in FIG. 6 using the event identifier 500 as a key returns an operator call-up, “call operator” (644), then the management device 100 requests event processing to an operator, by displaying the event identifier 500 and the attached information 800 on the display monitor 106, or the like.

In (“Update event status” 309) in FIG. 3, the management device 100 updates the event processing status, by adding an entry to the event status management data shown in FIG. 7 respectively registering the current acceptance number as the acceptance number 700, the current event identifier, as the event identifier 500, the processing time, as the time 701, and the processing status “Operator called” (760), as the status 702.

In (“Send response” 310), the management device 100 sends the acceptance number 700 assigned in (“Accept event” 303) to the management module 121 by a similar communications method to that used by the management device 100 in (“Send response” 310) in FIG. 8 described above. An identifier indicating an operator call-up may be included in the return message, in addition to the acceptance number 700, thereby reporting explicitly to the management module 121 that an operator call is being processed. Moreover, it is also possible to include information in the response message indicating the time for sending a subsequent (“Send enquiry”) operation 203(2), the transmission interval and number of transmission attempts, to the management module 121.

In (“Receive response” 205), the management module 121 receives a response message to the enquiry that was sent to the management device 100 in (“Send enquiry” 203), similarly to the (“Receive response” 205) operation performed by the management module 121 in FIG. 8 described above.

In (“Send enquiry” 203(2)), the management module 121 sends the enquiry to the management device 100 again, if the response message is found not to contain countermeasure information 601 when it is analyzed. The enquiry report includes the acceptance number 700 and reports that the enquiry is a repeat enquiry relating to the event for which an enquiry was sent in (“Send enquiry” 203). The settings for the timing, interval, number of transmission attempts, and the like, of the repeat enquiry are determined according to the instructions contained in the response message from the management device 100, or according to the settings in the management module 121.

In (“Receive enquiry” 301(2)), the management device 100 receives the enquiry, similarly to (“Receive enquiry” 301) described above.

In (“Re-accept event” 320), the management device 100 analyzes the enquiry message to investigate whether or not it contains an acceptance number 700. If it contains an acceptance number 700, then the management device 100 determines that the event is one that has already been accepted, and it searches the statuses 702 in the event status management table shown in FIG. 7 using the acceptance number 700 as a key, thereby ascertaining the processing status of the event for which the enquiry has been received.

In (“Update event status” 321) in FIG. 3, the management device 100 updates the event processing status, by adding an entry to the event status management table respectively registering the current acceptance number as the acceptance number 700, the current event identifier, as the event identifier 500, the processing time, as the time 701, and the processing status “Event re-accepted” (761), as the status 702.

In (“Send response” 310(2)), similarly to (“Send response” 310) described above, the management device 100 returns the acceptance number 700 to the management module 121, if no countermeasure information 601 can be acquired.

In (“Receive response” 205(2)), similarly to (“Receive response” 205) described above, the management module 121 receives a response message to the enquiry that was sent to the management device 100 in (“Send enquiry” 203(2)).

The management module 121 repeats the processing in (“Send enquiry” 203(2)) described above, a prescribed number of times or a set number of times specified by the management device 100, or until countermeasure information 601 of some kind is acquired.

In (“Contact administrator” 233) in FIG. 2, if the management module 121 has not obtained countermeasure information 601 from the management device 100 even after repeating a repeat enquiry a predetermined number of times, then it records the corresponding details in the log and reports these details to the administrator of the managed device 120, either by displaying them on the display monitor of the managed device 120, contacting the administrator by email, or by another method.

In (“Send enquiry” 203(3)), the management module 121 sends the enquiry to the management device 100 again, similarly to (“Send enquiry” 203(2)) described above.

In (“Receive enquiry” 301(3)), the management device 100 receives the enquiry, similarly to (“Receive enquiry” 301(2)) described above.

In (“Re-accept event” 320(3)), similarly to (“Re-accept event” 320) described above, the management device 100 searches the statuses 702 in the event status management table shown in FIG. 7, using the acceptance number 700 in the enquiry message as a key, thereby ascertaining the processing status of the event for which the enquiry has been received. It also updates the event processing status. If (Countermeasure information input by operator 900) is performed, then the status 702 for the corresponding acceptance number 700 in FIG. 7 is set to “Countermeasure information input by operator” (762). In this way, the management device 100 judges that the countermeasure information 601 can be acquired.

In (“Acquire countermeasure information” 308), the management device 100 acquires countermeasure information 601 input by the operator, similarly to the processing performed by the management device 100 in (“Acquire countermeasure information” 308) in FIG. 8, described previously. The countermeasure information 601 input by the operator is of similar content to the countermeasure information 601 described in the (“Acquire countermeasure information” 308) operation performed by the management device 100 in FIG. 8.

In the steps from (“Send response” 310(3)) to (“End” 215), the management module 121 and the management device 100 execute similar processing to that from step (“Send response” 310) to (“End” 215) performed by the management module 121 and the management device 100 in FIG. 8 described above.

In the foregoing processing, by retaining the countermeasure information 601 input by the operator in the event countermeasure information table shown in FIG. 6, in association with the first event enquiry, then from the second enquiry onwards, it is possible to shift to a mode where countermeasure information is sent without the operator's assistance as shown in FIG. 8.

Next, a case where the management module 121 works with an operator's assistance in exchanging messages with the management device 100 and performing the event countermeasures shown in FIG. 9, and where an information addition instruction is issued to the management module 121, will be described in a time sequence with reference to FIG. 10.

In the steps from (“Detect event” 201) to (“Receive enquiry” 301(2)), the processing is similar to that performed by the management module 121 and the management device 100 in FIG. 9 described above.

In (“Re-accept event” 320), the management device 100 ascertains the event processing status, similarly to the operation (“Re-accept event” 320) in FIG. 9 described above. If (“Addition of information instructed by operator” 1000) is performed, then the status 702 for the corresponding acceptance number 700 in the event status management table in FIG. 7 is set to “Addition of information instructed by operator”. In this way, the management device 100 judges that the operator is requesting addition of information.

In (“Instruct addition of information” 341), the management device 100 acquires an information addition instruction 1010. The information addition instruction 1010 is a command to the managed device 120 or management module 121, such as “get XXX configuration”, “get YYY log”, or “execute ZZZ and get AAA”, or a script indicating execution of such a command, or the like. A script indicating execution of a command may be prepared beforehand, or the command script may be generated dynamically by using the attached information 800 and a template script, or the like, each time the operator instructs addition of information.

In (“Send response” 310(2)), the management device 100 sends the acceptance number 700 and the information addition instruction 1010, to the management module 121, similarly to (“Send response” 310).

In (“Receive response” 205(2)), similarly to (“Receive response” 205) described above, the management module 121 receives a message in response to (“Send enquiry” 203(2)).

In (“Gather additional information” 231), the management module 121 analyzes the response message, and if it contains a command, script, or the like, forming an information addition instruction 1010, then it executes that command or script, and acquires the additional information 1011 requested by the management device 100. The additional information 1011 is information obtained by executing the command or script received as an information addition instruction 1010, such as the settings file (Configuration), error log, or the like, of the managed device 120 or management module 121. If there is a failure to execute the command or script, then an identifier such as “operation error” indicating an execution failure, or an error log, or the like, is included in the additional information 1011.

In (“Send enquiry” 203(3)), the management module 121 sends the acceptance number 700 and the additional information 1011 gathered in (“Gather additional information” 231) to the management device 100, similarly to (“Send enquiry” 203).

In (“Receive enquiry” 301(3)), the management device 100 receives the repeat enquiry message containing the acceptance number 700 and the additional information 1011, from the management module 121, similarly to the (“Receive enquiry” 301) operation described above.

In (“Re-accept event” 320(3)), similarly to (“Re-accept event” 320) described above, the management device 100 searches the statuses 702 in the event status management table shown in FIG. 7, using the acceptance number 700 in the enquiry message as a key, thereby ascertaining the processing status of the event for which the enquiry has been received. Furthermore, it also updates the event processing status.

In (“Update event status” 321) in FIG. 3, if the management device 100 has received additional information 1011, then it updates the event processing status, by adding an entry in the event status management table respectively registering the current acceptance number as the acceptance number 700, the current event identifier, as the event identifier 500, the processing time, as the time 701, and the processing status “Additional information acquired”, as the status 702.

In (“Present additional information” 342), if the management device 100 has received the additional information 1011, then “Additional information acquired” is registered as the status 702 for the corresponding acceptance number 700 in FIG. 7. Therefore, the management device 100 judges that it can present the additional information 1011 to the operator and it proceeds to present this additional information 1011 to the operator by displaying it on the display monitor 106, or the like.

In (“Update event status” 309) in FIG. 3, the management device 100 updates the event processing status, by adding an entry to the event status management table such as that shown in FIG. 7, respectively registering the current acceptance number as the acceptance number 700, the current event identifier, as the event identifier 500, the processing time, as the time 701, and the processing status “Additional information presented”, as the status 702.

In (“Send response” 310(3)), the management device 100 executes similar processing to that in the (“Send response” 310(2)) operation in FIG. 9 described above. If (“Addition of information instructed by operator” 1000) is implemented again, then the processing from (“Instruct addition of instruction” 341) to (“Re-accept event” 320(3)) is implemented again, in the management device 100 and the management module 121.

In the steps from (“Receive response” 205(3)) to (“End” 215), the management module 121 and the management device 100 execute similar processing to that from step (“Receive response” 205(2)) to (“End” 215) performed by the management module 121 and the management device 100 in FIG. 9 described above.

Next, a case where the management module 121 implements the event countermeasures illustrated in FIG. 8 by sending enquiries simultaneously to a plurality of management devices 100 is described in a time sequence, with reference to FIG. 11.

(“Detect event” 201) is similar to the processing illustrated in FIG. 8.

(“Find enquiry destination” 202) is similar to the processing illustrated in FIG. 8. An event occurring in the managed device 120 may be related to a plurality of parts or aspects of the system, such as the storage, network, or particular software or hardware, or it may be impossible to relate it to any one of a plurality of parts and aspects. In cases such as these, a plurality of enquiry destinations are specified simultaneously, as in “http://center.com/storage AND http://center.com/network” (524) shown in FIG. 5.

In the steps from (“Send enquiry” 203) to (“Receive response” 205), the management module 121 and the management device 100 forming the first enquiry destination located in (“Find enquiry destination” 202) execute processing similar to that in FIG. 8.

Moreover, similar processing is also carried out if there is a second or third enquiry destination.

Using the conditions 600 shown in the event countermeasure information table in FIG. 6, the management device (2) 100(2) may also be set so as to send countermeasure information (2) 601(2) if the acceptance number 700 from the management device 100 is included in the enquiry message. In this case, in the comments 503 corresponding to the event identifier 500 in the event enquiry table shown in FIG. 5, it is previously stated that the acceptance number 700 from the management device 100 is required in order to send the enquiry to the management device (2) 100(2), and the management module 121 includes the acceptance number 700 from the management device 100 in additional information (2) 800(2), which is sent to the management device (2) 100(2).

If a condition that the enquiry has been accepted by the management device 100 is not set as a condition 600 in the event countermeasure information table in management device (2) 100(2), then the management module 121 may make an enquiry to the management device (2) 100(2), simultaneously, without waiting for the (“Receive response” 205) operation for the enquiry sent to the management device 100.

In (“Execute countermeasure” 208), the management module 121 analyzes the response messages from the management device 100 and the management device (2) 100(2), and it executes the countermeasure information 601 and the countermeasure information (2) 601(2). Information indicating whether both or either one of the countermeasure information 601 and/or countermeasure information (2) 601(2) is to be implemented, the order of their implementation, and the like, is stated previously in the comments 503 corresponding to the event identifier 500.

In the steps from (“Send countermeasure completion report” 209) to (“Receive response” 211), similar processing to that in FIG. 8 is implemented.

Moreover, if there is a second or third enquiry destination, then similar processing is carried out in these cases also.

If it is previously specified that an acceptance number 700 from the management device 100 is required for transmission to the management device (2) 100(2), then the acceptance number 700 from the management device 100 is included in the countermeasure completion information (2) 801(2) sent to the management device (2) 100(2).

If a condition that the enquiry has been accepted by the management device 100 is not set as a condition 600 in the event countermeasure information table in management device (2) 100(2), then the management module 121 may send a countermeasure completion report to the management device (2) 100(2), simultaneously, without waiting for the (“Receive response” 211) operation relating to the countermeasure completion report sent to the management device 100.

Next, a case where the management module 121 implements the event countermeasures illustrated in FIG. 8 by sending enquiries consecutively to a plurality of management devices 100 is described in a time sequence, with reference to FIG. 12.

(“Detect event” 201) is similar to the processing illustrated in FIG. 8.

(“Find enquiry destination” 202) is similar to the processing illustrated in FIG. 8. After a primary countermeasure has been implemented by a first management device in response to an event occurring in the managed device 120, a secondary countermeasure may be implemented by a second management device. In cases such as these, a plurality of consecutive enquiry destinations are specified, as in “http://center.com/server, http://center.com/staff” (525) shown in FIG. 5.

In the steps from (“Send enquiry” 203) to (“Receive response” 211), similar processing to that in FIG. 8 is carried out, and implementation of an event countermeasure by the first management device 100 is completed.

In the steps from (“Send enquiry” 203(2)) to (Accept event 303(2)), similar processing to that in FIG. 8 is carried out.

In (“Find countermeasure information” 305(2)), the management device 100(2) finds countermeasure information 601 for the event, using the event identifier 500 as a key. In this case, it is possible to set a condition 600 corresponding to the event identifier 500 in the event countermeasure information table shown in FIG. 6, stating a requirement that the enquiry has already been processed by the management device 100, as in “processed by server 1” (632). In this case, it is stated previously in the comments 503 corresponding to that event identifier 500 in the event enquiry destination table shown in FIG. 5, that an acceptance number 700 and countermeasure completion acceptance information 802 from the management device 100 are required for transmission to the management device (2) 100(2). The management module 121 includes the acceptance number 700 and the countermeasure completion acceptance information 802 from the management device 100, in additional information (2) 800(2), and sends this to the management device (2) 100(2).

In the steps from (“Acquire countermeasure information” 308(2)) to (“End” 215), the management module 121 and the management device (2) 100(2) execute similar processing to that from step (“Acquire countermeasure information” 308) to (“End” 215) performed by the management module 121 and the management device 100 in FIG. 8 described above.

Moreover, if there is a third enquiry destination, then similar processing to that from step (“Send enquiry” 203(2)) to (“Receive response” 211(2)) is carried out.

Finally, a case where the management module 121 has made an enquiry to the management device 100, and an event countermeasure is implemented by transferring the enquiry to another management device (2) 100(2), rather than making an enquiry to the operator as shown in FIG. 9, is now described in a time sequence with reference to FIG. 13.

In enquiry transfer processing, even if the countermeasure information is actually provided by various dedicated management devices, the enquiry destination is still treated as the same destination by the management module 121.

In the steps from (“Detect event” 201) to (“Find countermeasure method” 305), the management module 121 and the management device 100 execute similar processing to that from step (“Detect event” 201) to (“Find countermeasure method” 305) performed by the management module 121 and the management device 100 in FIG. 9 described above.

In (“Transfer enquiry” 343), if the result of the search using the event identifier 500 as a key indicates transfer of the enquiry to another management device, as in “transfer http://maintenance.com/storage” (645) in FIG. 6, then the management device 100 transfers the event identifier 500 and the attached information 800(2) it has received, to the management device (2) 100(2) designated as the transfer destination.

In (“Update event status” 309) in FIG. 3, the management device 100 updates the event processing status, by adding an entry to the event status management table shown in FIG. 7 respectively registering the current acceptance number as the acceptance number 700, the current event identifier, as the event identifier 500, the processing time, as the time 701, and the processing status “Enquiry transferred”, as the status 702.

The management device 100 may transfer the attached information 800 to the management device (2) 100(2), directly, without modification, but it may also change the data to a format specified for management device (2) 100(2), and append an acceptance number 700, thereby indicating explicitly that the enquiry has been accepted by the management device 100.

The steps from (“Send response” 310) to (“Receive response” 205) are similar to the processing illustrated in FIG. 9.

In the steps from (“Receive enquiry” 301(3)) to (“Send response” 310(3)), the management device (2) 100(2) carries out similar processing to that performed by the management device 100 from (“Receive enquiry” 301) to (“Receive response” 310) in FIG. 8. Using the conditions 600 in the event countermeasure method data in FIG. 6, the management device (2) 100(2) may also send countermeasure information 601, if the acceptance number 700 from the management device 100 is included in the enquiry message.

In (“Receive transfer response” 1300), the management device 100 receives an acceptance number (2) 700(2) and the countermeasure information 601, from the management device (2) 100(2), as a response to the transferred enquiry. Furthermore, the event processing status is updated by adding an entry to the event status management table shown in FIG. 7, registering “Receive transfer response” as the status 702 for the current acceptance number 700.

In the steps from (“Send enquiry” 203(2)) to (“Receive enquiry” 301(2)), similar processing to that in FIG. 9 is carried out.

In (“Re-accept event” 320), the management device 100 performs similar processing to that performed by the management module 121 in step (“Re-accept event” 320) in FIG. 9, and it ascertains the event processing status by referring to the event status management table. It also updates the event processing status.

If a response to the transferred enquiry is received from the management device (2) 100(2), then “Transfer response received” is registered in the status 702 for the current acceptance number 700 in FIG. 7. In this way, the management device 100 judges that the countermeasure information 601 can be acquired.

In (“Acquire countermeasure information” 308), the management device 100 acquires countermeasure information 601 sent by the management device (2) 100(2), similarly to the processing performed by the management device 100 in (“Acquire countermeasure information” 308) in FIG. 9, described previously. This countermeasure information 601 is of similar content to the countermeasure information 601 described in the (“Acquire countermeasure information” 308) operation performed by the management device 100 in FIG. 8.

In (“Send response” 310(2)), the management device 100 sends the acceptance number 700 and the countermeasure information 601(2) to the management module 121, similarly to the (“Send response” 310(3)) operation performed by the management device 100 in FIG. 9 described above. The countermeasure information 601(2) may be the countermeasure information 601 received from the management device (2) 100(2), in an unmodified state, or it may be converted into a data format suited to the management module 121. Furthermore, new countermeasure information 601(2) may be creating by adding information relating to the management device 100, to the countermeasure information 601 obtained from the management device (2) 100(2).

In the steps from (“Receive response” 205(2)) to (“Accept completion of countermeasure” 402), the management module 121 and the management device 100 execute similar processing to that from step (“Receive response” 205(3)) to (“Accept completion of countermeasure” 402) performed by the management module 121 and the management device 100 in FIG. 9 described above.

In (“Transfer countermeasure completion report” 410), the management device 100 transfers the countermeasure completion report received from the management module 121, to the management device (2) 100(2), as described above in the step (“Transfer enquiry” 343).

In (Update event status 411) in FIG. 4, the management device 100 updates the event processing status, by adding an entry to the event status management table shown in FIG. 7, respectively registering the current acceptance number as the acceptance number 700, the current event identifier, as the event identifier 500, the processing time, as the time 701, and the processing status “Countermeasure completion report transferred”, as the status 702.

The acceptance number (2) 700(2) received from the management device (2) 100(2) and the countermeasure completion information (2) 801(2) are included in the countermeasure completion report. The countermeasure completion information (2) 801(2) may use the countermeasure completion information 801 received from the management module 121, directly, without modification, or it may convert the data to a format specified by the management device 100(2). Furthermore, by appending an acceptance number 700 or countermeasure completion acceptance information 802 it is possible to state explicitly that the enquiry has been accepted by the management device 100, or that processing has terminated.

In the steps from (Receive countermeasure completion report 401(3)) to (“Send response” 406(3)), the management device (2) 100(2) executes similar processing to that from step (Receive countermeasure completion report 401) to (“Send response” 406) performed by the management device 100 in FIG. 8 described above.

In the steps from (“Send response” 406) to (“End” 215), the management module 121 and the management device 100 execute similar processing to that from step (“Send response” 406) to (“End” 215) performed by the management module 121 and the management device 100 in FIG. 9 described above.

In (Receive transfer response 1301), the management device 100 receives an acceptance number (2) 700(2) and countermeasure completion acceptance information (2) 802(2), from the management device (2) 100(2), as a response to the transferred countermeasure completion report. Furthermore, the event processing status is updated by adding an entry to the event status management table shown in FIG. 7, registering “Response to transferred countermeasure completion report received” as the status 702 for the current acceptance number 700.

As described above, the remote management system relating to the present embodiment provides the following characteristics and functions. More specifically, in the present embodiment, events occurring in a managed device 120 are managed by an event scheme that can be adapted to a plurality of managed devices 120, and a management module 121 is located inside the managed device 120. The management module 121 detects an event in the managed device 120, and makes an enquiry by sending an event identifier 500 to the management device 100.

The management device 100 receives the enquiry from the management module 121, accepts the event in the managed device 120, manages the event status by means of an event status management table, searches for countermeasure information 601 corresponding to the event identifier 500, from an event countermeasure information table, and sends the event acceptance number 700 and countermeasure information 601 to the management module 121.

The management module 121 implements the countermeasure information 601 received from the management device 100 and reports completion of the event countermeasure by sending the acceptance number 700 and countermeasure completion information 801 to the management device 100. The management device 100 accepts the event countermeasure completion report sent by the management module 121.

By means of these operations, simple and scalable remote management can be achieved, without needing to change the settings of the firewall 122 on the managed device 120 side or to identify the address of the managed device 120, and without needing to add settings to the management device 100 if the number of managed devices 120 is increased.

Moreover, the management module 121 locates one or more than one enquiry destination 501 corresponding to the event in an event enquiry destination table, and by making an enquiry to another management device 100 if there is no response from one management device 100, or making enquiries to a plurality of management devices 100 simultaneously, or making enquiries to a plurality of management devices 100 consecutively, the managed device 120 is able to acquire the event countermeasure information 601 in a reliable manner, and the management of the managed devices 120 can be implemented in a shared or co-operative fashion, by a plurality of management devices 100.

Furthermore, by searching the event countermeasure information table and obtaining a countermeasure information 601 corresponding to an enquiry condition 600 for the event in the management module 121, the management device 100 is able to change the countermeasure information 601 provided, in accordance with the enquiry condition 600, such as the time period, and hence countermeasures 601 corresponding to the actual situation can be provided.

Moreover, since the management module 121 repeats an enquiry to the management device 100 until the management device 100 provides countermeasure information 601, then it is possible for the management device 100 to exchange information with the managed device 120 in a interactive fashion, via an operator, and therefore it is possible to implement countermeasures for an event reliably, even if an unexpected event has occurred in the managed device 120.

Furthermore, since an enquiry destination is assigned in cases where one or more enquiry destinations corresponding to the event identifier 500 are not defined in the event enquiry destination table, then it is possible for the management module 121 to determine an enquiry destination and implement event countermeasures reliably, even in the case of an event which does not coincide with a standard information management scheme or common information management scheme.

Furthermore, since the management device 100 registers countermeasure information 601 to be used in a case where no countermeasure information corresponding to the event identifier 500 is registered in the event countermeasure information table, then the management device 100 is able to determine countermeasure information 601 and cause event countermeasures to be implemented reliably, even in the case of an event which does not coincide with a standard information management scheme or common information management scheme.

Moreover, since the management device 100 assigns countermeasure information 601 indicating an operator call-up in cases where no countermeasure information corresponding to the event identifier is registered in the event countermeasure information table, then it is possible to implement event countermeasures reliably on the basis of a response from an operator, even in the case of an event which does not coincide with a standard information management scheme or common information management scheme.

Furthermore, since the management module 121 provides additional information to the management device 100 when an enquiry is repeated, it is possible to provide the necessary information required to devise a countermeasure for an event in the management device 100, and therefore event countermeasures can be implemented reliably.

Moreover, since the management module 121 reports the occurrence of an error during the event countermeasure process to the administrator of the managed device 120, if no response to an enquiry is received from the management device 100, or if countermeasure information 601 is not provided by the management device 100, or if no response to an event countermeasure completion report is received from the management device 100, then it is possible to implement event countermeasures reliably.

Furthermore, since the management module 121 is able to report the progress and results of the event countermeasures 601 received from the management device 100, to the administrator of the managed device 120, then it is possible to implement event countermeasures reliably.

The specification and drawings are, accordingly, to be regarded in an illustrative rather than a restrictive sense. It will, however, be evident that various modifications and changes may be made thereto without departing from the spirit and scope of the invention as set forth in the claims.

1. A remote management system comprising a managed device and a management device connected via a network;
wherein the managed device comprises:
means for detecting an event occurring in the managed device; and
means for sending an enquiry containing an identifier for the event, to the management device;
and the management device comprises:
means for receiving an enquiry containing the event identifier from the managed device;
means for locating countermeasure information corresponding to the event identifier in an event countermeasure information table provided in order to manage the processing status of events; and
means for sending the countermeasure information to the managed device;
the managed device further comprising:
means for receiving the countermeasure information from the management device;
means for implementing the event countermeasure on the basis of the received countermeasure information; and
means for reporting that the countermeasure for the event has been completed, to the management device;
and the management device further comprising:
means for receiving a countermeasure completion report for the event from the managed device.

2. The remote management system according to claim 1,
wherein the managed device comprises:
means for locating one or more enquiry destinations corresponding to the event identifier, in an event enquiry destination table provided in the managed device; and
means for making an enquiry to the one or more enquiry destinations.

3. The remote management system according to claim 1,
wherein the management device comprises means for locating countermeasure information corresponding to an enquiry condition specified by the managed device, in the event countermeasure information table.

4. The remote management system according to claim 1,
wherein the managed device comprises means for repeatedly sending the enquiry to the management device, until the countermeasure information is provided.

5. The remote management system according to claim 2,
wherein the event enquiry destination table in the managed device comprises an enquiry destination for cases where no enquiry destination corresponding to the event identifier is defined.

6. The remote management system according to claim 1,
wherein the event countermeasure information table in the management device comprises countermeasure information for use in cases where no countermeasure information corresponding to the event identifier has been registered.

7. The remote management system according to claim 6,
wherein the event countermeasure information table in the management device defines an operator call-up as the countermeasure information for use in cases where no countermeasure information corresponding to the event identifier has been registered.

8. The remote management system according to claim 4,
wherein the managed device comprises means for adding information when repeating an enquiry.

9. The remote management system according to claim 1,
wherein the managed device comprises means for providing a report to the administrator of the managed device, if no response to the enquiry is obtained from the management device, or if no countermeasure information is provided by the management device, or if no response to the event countermeasure completion report is obtained from the management device.

10. The remote management system according to claim 1,
wherein the managed device comprises-means for reporting the received countermeasure information to the administrator of the managed device.
